(19) United States
(12) Patent Application Publication
(10) Pub. No.: US 2005/0010408 A1
(43) Pub. Date: Jan. 13, 2005

(54) Likelihood calculation device and method therefor

(75) Inventors: Kenichiro Nakagawa, Tokyo (JP); Masayuki Yamada, Tokyo (JP)

Correspondence Address: Canon U.S.A. Inc.,;Intellectual Property Department, 15975 Alton Parkway, Irvine, CA, 92618-3731, US

(73) Assignee: Canon Kabushiki Kaisha, Tokyo (JP)

(21) Appl. No.: 10/873,905

(22) Filed: Jun. 22, 2004

(30) Foreign Application Priority Data
Jul. 7, 2003 (JP) 2003-193113

(51) Int. Cl. G10L 15/00

(52) U.S. Cl. 704/240

(57) ABSTRACT

A device and method for calculating likelihood of an observed feature parameter for a plurality of standard patterns. Coefficients used in an equation for calculating likelihood for each of a plurality of standard patterns are generated and stored in a database. Further, a power of the observed feature parameter is calculated. The likelihood is calculated via a product-sum calculation based on the calculated power and the coefficients corresponding to the powers.

### BACKGROUND OF THE INVENTION

1. Field of the Invention

The present invention relates to a likelihood-calculation processing technique used for various pattern recognition devices including a speech recognition device or the like.

2. Description of the Related Art

According to general recognition algorithms, a score of a standard pattern (a recognition object) and an observed feature parameter are calculated, and the standard pattern with a highest score is outputted as a recognition result.

A probability-density function is often used for representing the standard pattern. In this case, an observed feature parameter is inputted into the probability-density function as a probability variable for calculating a likelihood. The above-described score can be obtained by using the calculated likelihood. For example, the observed feature parameter is determined to be n-dimensional parameters (x₁, x₂, . . . , and xₙ) that are independent of one another. The m-th standard pattern is determined to be cm. Where an n-dimensional probability-density function constituting the standard pattern ωₘ is formed by a normal distribution of N(μ_{m,i}, and σ2_{m,i}) independent of each other (where μ indicates an average value, σ2 indicates a distribution value, and 1≦i≦n), likelihood P(x|ωₘ) of the observed feature parameter x of the standard pattern m can be determined, as shown in the following equation.
[Expression 1]

$$P ( x \vert {ω}_{m} ) = {\prod }_{i = 1}^{n} \frac{1}{\sqrt{2 π {σ}_{m , i}^{2}}} {ⅇ}^{\frac{- {( {x}_{i} - {μ}_{m , i} )}^{2}}{2 {σ}_{m , i}^{2}}} \qquad ( 1 )$$

The logarithm shown in Equation (1) can be used for simplifying the calculation. In this case, the log likelihood can be calculated, as shown below.
[Expression 2]

$$Log P ( x \vert {ω}_{m} ) = {\sum }_{i = 1}^{n} \{ - \frac{1}{2} log ( 2 {πσ}_{m , i}^{2} ) - \frac{{( {x}_{i} - {μ}_{m , i} )}^{2}}{2 {σ}_{m , i}^{2}} \} \qquad ( 2 )$$

The above-described recognition method using these likelihood calculations is used for speech recognition, image recognition, hand-written character recognition, and so forth.

Recognition algorithm using likelihood calculation is disclosed in Patent Document 1 (Japanese Patent Publication No. 7-72838), for example.

The recognition algorithm using the likelihood calculations according to the above-described equations has the following problems. Particularly, it is difficult to use this recognition algorithm for small systems with small calculation resources, for example.

(i) Where the number of standard patterns and dimensions for recognition increases, a data storing area for representing a distribution such as μ_{m,i}, and σ2_{m,i} increases.

(ii) Where the number of standard patterns and dimensions for recognition increases, an increased amount of calculations causes the recognition speed of a system with small calculation resources to decrease.

(iii) General consumer systems often use an inexpensive fixed-point signal processor in place of a floating-point signal processor. Where the fixed-point signal processor is used, the likelihood calculation must be performed through fixed-point calculation. In this case, a quantization error occurs due to the fixed-point processing, thereby decreasing a recognition performance of the system. Particularly, according to Equation (2), multiplication is performed after cancellation occurs by addition and subtraction. Therefore, an increased cancellation error occurs.

Patent Document 1 discloses a speech-recognition technique for performing quantization by changing a quantization width of a feature parameter (Cepstrum coefficient) for each dimension. As such, deterioration of the feature parameter due to the fixed-point processing is prevented. This efficient quantization is effective for reducing the data storing area.

Although this method can be used for registration-type(speaker-dependent) speech recognition, it cannot be used for recognition algorithm using the probability density function.

Accordingly, it is desirable to have a system with small calculation resources capable of performing likelihood calculations for recognition processing using a probability-density function with high precision and high speed.

### SUMMARY OF THE INVENTION

The present invention is directed to a device and method for calculating likelihood of an observed feature parameter for a plurality of standard patterns. In one aspect of the present invention, the method includes generating a set of coefficients of power series of the observed feature parameter for each of the standard patterns, calculating a power of the observed feature parameter for each of the standard patterns, and calculating the likelihood of the observed feature parameter for each of the plurality of standard patterns. In one embodiment, calculating the likelihood includes performing a product-sum calculation based on the set of coefficients and the corresponding powers. In another embodiment of the present invention, the method includes quantizing the set of coefficients, providing a set of scaling parameters corresponding to the quantized set of coefficients, and calculating the likelihood including performing a product-sum calculation based on the calculated power, the corresponding quantized set of coefficients, and the corresponding set of scaling parameters.

Further features and advantages of the present invention will become apparent from the following description of the embodiments (with reference to the attached drawings).

### BRIEF DESCRIPTION OF THE DRAWINGS

FIG. 1 is a block diagram of a device for calculating likelihood according to one embodiment of the present invention.

FIG. 2 is a flowchart illustrating a process for generating and storing coefficients in a database according to one embodiment of the present invention.

FIG. 3 is a flowchart illustrating a process for calculating likelihood according to one embodiment of the present invention.

FIG. 4 is a flowchart illustrating a process for generating and storing coefficients in a database according to another embodiment of the present invention.

FIG. 5 is a flowchart illustrating a process for calculating likelihood according to another embodiment of the present invention.

### DESCRIPTION OF THE PREFERRED EMBODIMENTS

First Embodiment

Embodiments of the present invention will now be described with reference to the attached drawings. Here, example likelihood calculations using a normal distribution as a probability-density distribution is shown. First, a calculation method used for the present invention will be described, and then functional configuration and details of processing will be described.
n-dimensional probability-density functions constituting the m-th standard pattern (ωₘ) correspond to a normal distribution of N(μ_{m,i} and σ2_{m,i}) (where μ indicates an average value, σ2 indicates a distribution value, and 1≦i≦n). Where observed n-dimensional feature parameters that are independent of one another are determined to be x₁, x₂, . . . , and xₙ, an equation for calculating a log likelihood becomes the same as the above-described Equation (2). Further, in this embodiment, a predetermined parameter is observed as a feature parameter and will be referred to as an observed feature parameter in the following description.

According to Equation (2), multiplication is performed after cancellation is caused by addition and subtraction. Subsequently, where a fixed-point calculator calculates this equation, an increased cancellation error occurs. Therefore, this calculation is expanded into power series of x, as shown in the following equation.
[Expression 3]

$$\begin{matrix}Log P ( x \vert {ω}_{m} ) = {\sum }_{i = 1}^{n} \{ - \frac{{μ}_{m , i}^{2}}{2 {σ}_{m , i}^{2}} - \frac{1}{2} log ( 2 {πσ}_{m , i}^{2} ) \} + \\ {\sum }_{i = 1}^{n} \{ - \frac{1}{2 {σ}_{m , i}^{2}} {x}_{i}^{2} \} + {\sum }_{i = 1}^{n} \{ - \frac{{μ}_{m , i}}{{σ}_{m , i}^{2}} {x}_{i} \}\end{matrix} \qquad ( 3 )$$

Here, coefficients of the power series of x are shown in the following equations.
[Expression 4]

$${A}_{m} = {\sum }_{i = 1}^{n} \{ - \frac{{μ}_{m , i}^{2}}{2 {σ}_{m , i}^{2}} - \frac{1}{2} log ( 2 {πσ}_{m , i}^{2} ) \} \\ {B}_{m , i} = - \frac{1}{2 {σ}_{m , i}^{2}} \\ {C}_{m , i} = - \frac{{μ}_{m , i}}{{σ}_{m , i}^{2}} \qquad ( 4 )$$

By using the above-described coefficients, Equation (3) can be changed into the following equation.
[Expression 5]

$$Log P ( x \vert {ω}_{m} ) = {A}_{m} + {\sum }_{i = 1}^{n} \{ {B}_{m , i} {x}_{i}^{2} \} + {\sum }_{i = 1}^{n} \{ {C}_{m , i} {x}_{i} \} \qquad ( 5 )$$

Since each of the coefficients Aₘ, B_{m,i}, and C_{m,i} does not include the observed feature parameter x, these coefficients can be calculated beforehand (during the distribution training). These coefficients Aₘ, B_{m,i}, and C_{m,i} are hereinafter referred to as coefficient data.

The likelihood calculation using Equation (5) has the following advantages.

(i) The likelihood calculation (recognition processing) can be performed by simple product-sum calculations. Recently available embedded CPUs often have an Multiply and Accumulation (MAC) processor. The calculation shown in Equation (5) can be performed with high speed by using the instruction repertory.

(ii) The coefficient data Aₘ, B_{m,i}, and C_{m,i} can be calculated beforehand by a system supporting floating-point calculations during the distribution training. Subsequently, where a system incapable of supporting the floating-point calculation is used for the recognition processing, an error caused by the fixed-point calculation occurs only in the product-sum-calculation part of Equation (5). Since addition is performed after multiplication, occurrences of cancellation errors are minimal.

The following two process procedures are required for performing the likelihood calculation by using Equation (5).

(i) Coefficient data are prepared before recognition processing is performed. Where the above-described normal distribution is used, the coefficient data Aₘ, B_{m,i}, and C_{m,i} shown in Equation (4) are prepared.

(ii) The power of an observed feature parameter required for likelihood calculation performed for the recognition processing is calculated. Where the above-described normal distribution is used, the powers of x and x2 are calculated beforehand.

The calculation of (i) can be performed during the distribution training (during μ_{m,i}, and σ2_{m,i} are estimated). Where a system capable of training the distribution is used, the amount of calculations performed in the process (i) causes minimal problems. The process (ii) must be performed in the system that performs the recognition process. However, since the system has to perform the process (ii) only once every time the observed feature parameter is inputted, the load on the system hardly increases.

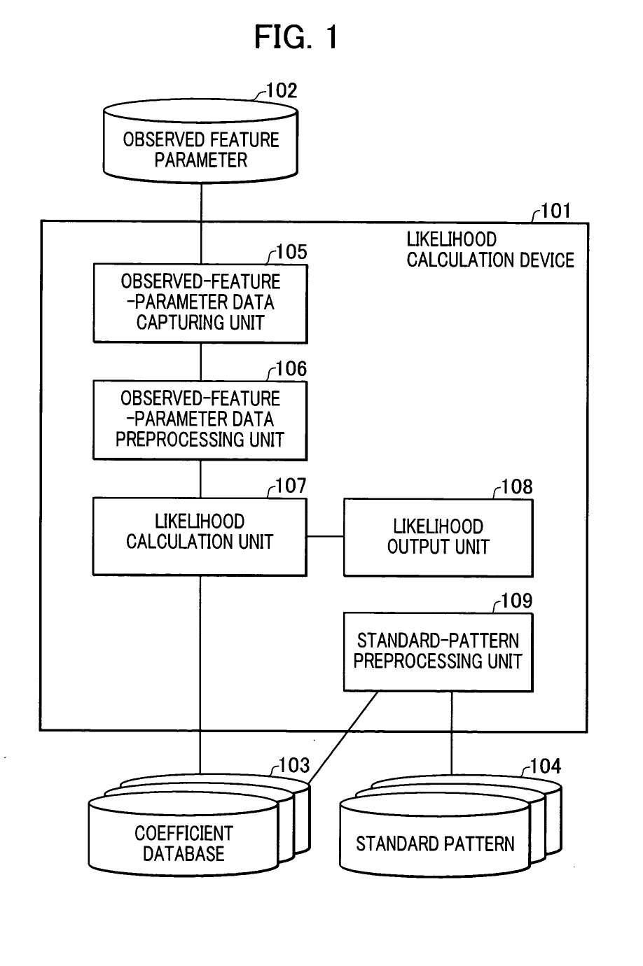

A likelihood calculation device according to the present invention uses the above-described likelihood-calculation algorithm. FIG. 1 is a block diagram of a likelihood calculation device 101 according to a first embodiment of the present invention.

The likelihood calculation device 101 has a standard-pattern preprocessing unit 109 for preprocessing the probability-density distribution, including μ_{m,i}, σ2_{m,i}, and so forth, (the probability-density distribution constituting a standard pattern 104) and changing/converting them into coefficient data. Then, this coefficient data is stored in a coefficient database 103. In this embodiment, Aₘ, B_{m,i}, and C_{m,i} are calculated and stored via the above-described process. Alternatively, a system supporting floating-point calculations may be provided as the standard-pattern preprocessing unit 109, and obtained coefficient database 103 may be transmitted to the likelihood calculation device 101.

During the recognition process, an observed feature parameter 102 is inputted to the likelihood calculation device 101. This observed feature parameter 102 indicates the amount of feature including user's voice, handwriting, face image, and so forth. This data is transmitted to the likelihood calculation device 101 by an observed-feature-parameter capturing unit 105.

The captured observed feature parameter is transmitted to an observed-feature-parameter preprocessing unit 106, which calculates the power of the observed feature parameter required for the likelihood calculation. In the above-described embodiment using the normal distribution, the square of the observed feature parameter becomes necessary in addition to the observed feature parameter. Therefore, the observed-feature-parameter preprocessing unit 106 calculates the square of the observed feature parameter.

A likelihood calculation unit 107 calculates a log likelihood for each probability-density function through product-sum calculation such as Equation (5) by using the coefficient database 103, the observed feature parameter, and the power thereof.

The calculated log likelihood is outputted to components external to the likelihood calculation device 101 via a likelihood output unit 108. At this time, all calculated log likelihoods may be outputted, or only a maximum log likelihood may be outputted.

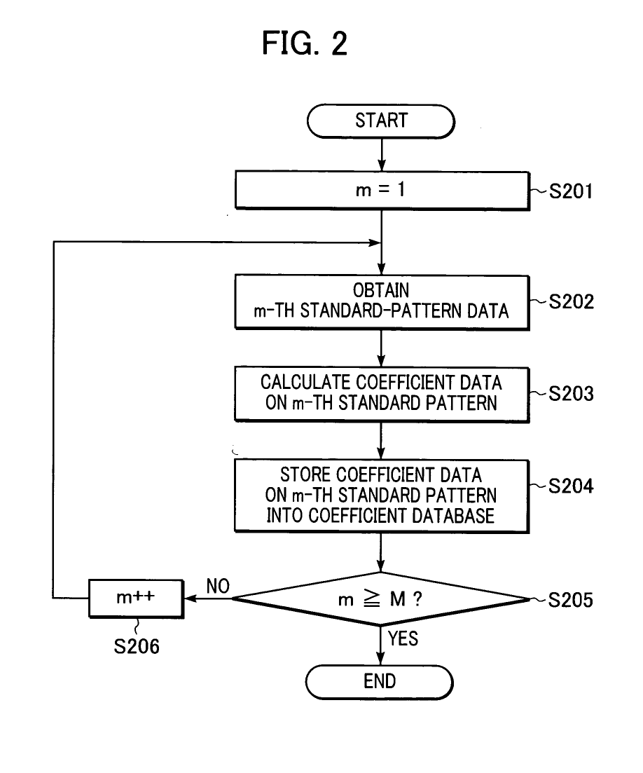

FIG. 2 is a flowchart showing a process for generating the coefficient database 103 according to the first embodiment. This process is performed by the standard-pattern preprocessing unit 109.

First, a counter variable m of a standard pattern to be processed is initialized to one, at step S201. Values including μ_{m,i}, σ2_{m,i}, and so forth, indicating a probability-density function forming the m-th standard pattern are obtained, at step S202.

Then, coefficient data is calculated from the obtained data including μ_{m,i}, σ2_{m,i}, and so forth, at step S203. The coefficient data corresponds to Aₘ, B_{m,i}, and C_{m,i} shown in the above-described Equation (4), for example. The calculated coefficient data is stored in the coefficient database 103, at step S204.

It is determined whether or not the value of the counter variable m exceeds a total number M of standard patterns, at step S205. If the value exceeds the total number M, the process is terminated. Otherwise, the process advances to step S206 where the value of the counter variable m is incremented by one. Then, the process returns to step S202 so that the process steps S202 to S204 are repeated. In the above-described manner, the process of steps S202 to S204 is performed for all standard patterns.

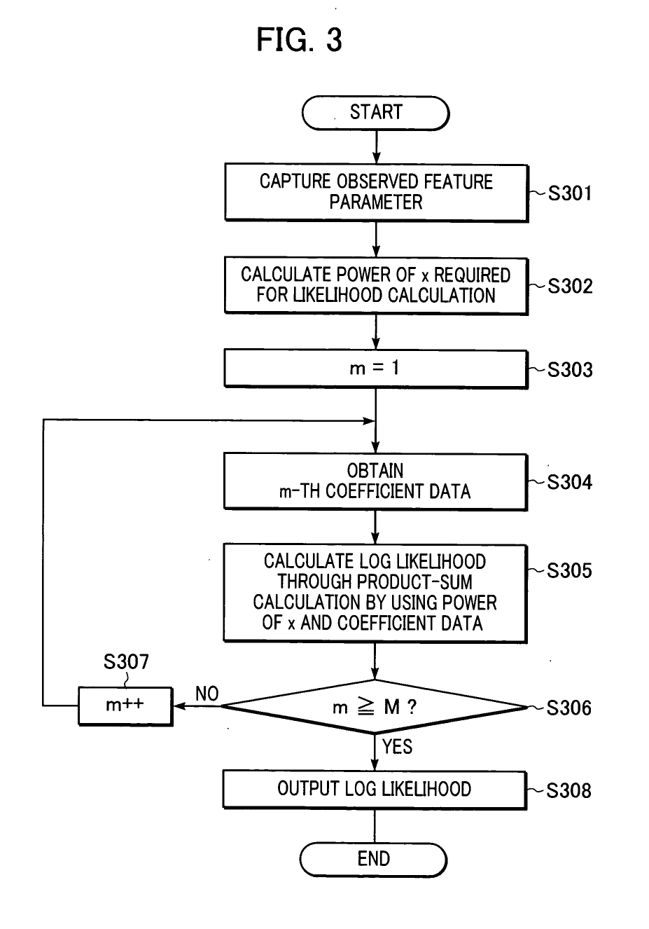

FIG. 3 is a flowchart illustrating a process for likelihood calculation in this first embodiment.

First, the observed-feature parameter capturing unit 105 captures an observed feature parameter x, at step S301. This observed feature parameter x may be an n-dimensional parameter.

Next, the observed-feature parameter preprocessing unit 106 calculates the power of x required for the likelihood calculation, at step S302. If Equation (5) is used in the likelihood calculation, x2 is calculated here.

The likelihood calculation unit 107 performs the processing of steps S304 to S307. First, the counter variable m of a standard pattern to be processed is initialized to one, at step S303. The m-th coefficient data is obtained from the coefficient database 103, at step S304. The coefficient data in the coefficient database 103 is generated through the coefficient-database construction process performed by the standard-pattern preprocessing unit 109. Then, a product sum calculation is performed according to Equation (5) based on the coefficient data and the power of x calculated at step S302. Subsequently, a log likelihood is calculated, at step S305.

It is determined whether or not the value of the counter variable m exceeds the total number M of standard patterns, at step S306. If the value exceeds the total number M, the process advances to step S308. Otherwise, the process advances to step S307 where the value of the counter variable m is incremented by one. Then, the process returns to step S304, and the process is repeated. In the above-described manner, steps S304 and S305 are performed for all standard patterns.

Then, at step S308, the likelihood output unit 108 outputs a log likelihood calculated through the above-described process.

Second Embodiment

In a second embodiment, a method for calculating likelihood using quantized coefficient data will be described.

In the case in which the log likelihood is calculated with Equation (5), the coefficient data including Aₘ, B_{m,i}, C_{m,i} and so forth, is required. Since the number of data items increases according to the number of standard patterns for comparison, or the dimension number of feature parameters, the data may be compressed. Particularly, when the recognition process is performed only by the fixed-point calculation, it is not necessary to have Aₘ, B_{m,i}, and C_{m,i}, as floating-point type values. Therefore, a method for quantizing Aₘ, B_{m,i}, and C_{m,i} into n-bit integer values will now be described.

Since the dynamic range of the coefficient data significantly changes according to the dimension of the feature parameters, the quantization width of the coefficient data may preferably be changed according to the dimension.

First, the averages of all standard patterns including Aₘ, B_{m,i}, and C_{m,i} are calculated for every dimension, as shown in the following equation. It should be noted that M indicates the total number of standard patterns.
[Expression 6]

$$\overline{A} = \frac{{\sum }_{m = 1}^{M} {A}_{m}}{M} \\ {\overline{B}}_{i} = \frac{{\sum }_{m = 1}^{M} {B}_{m , i}}{M} \\ {\overline{C}}_{i} = \frac{{\sum }_{m = 1}^{M} {C}_{m , i}}{M} \qquad ( 6 )$$

Further, standard deviations of Aₘ, B_{m,i}, and C_{m,i} in the entire standard patterns are calculated according to the following equation.
[Expression 7]

$${A}^{⋒} = \sqrt{\frac{{\sum }_{m = 1}^{M} {( \overline{A} - {A}_{m} )}^{2}}{M}} \\ {{B}^{⋒}}_{i} = \sqrt{\frac{{\sum }_{m = 1}^{M} {( {\overline{B}}_{i} - {B}_{m , i} )}^{2}}{M}} \\ {{C}^{⋒}}_{i} = \sqrt{\frac{{\sum }_{m = 1}^{M} {( {\overline{C}}_{i} - {C}_{m , i} )}^{2}}{M}} \qquad ( 7 )$$

The standard deviations are used for setting a suitable quantization width for each dimension indicated by i. Where the coefficient data needs to be compressed into p bit, maximum a, bᵢ, and cᵢ (referred to as scaling parameters) satisfying the following equation are obtained. In this equation, O indicates a constant for determining the quantization precision. This constant value may be about positive three. Where the distribution of Aₘ, B_{m,i}, and C_{m,i} is a normal distribution and where 0 equals three, 99.98% of the data is quantized into p bit.

[Expression 8]
2^{a}OÂ<2^{p-1}
2^{b}^{ᵢ}O\hat{B}ᵢ<2^{p-1}
2^{c}^{ᵢ}OĈᵢ<2^{p-1} (8)

Then, Aₘ, B_{m,i}, and C_{m,i} are quantized according to the following equation by using the calculated scaling parameters a, bᵢ, and cᵢ. The quantized values are shown as A′ₘ, B′_{m,i}, and C′_{m,i} that are integer values clipped at ±2^{p-}1.

[Expression 9]
A′ₘ2^{a}(Aₘ−\overline{A})
A′=−2^{p-1}, where A′<−2^{p-1}
and A′=2^{p-1}−1, where A′>2^{p-1}−1
B′_{m,i}=2_{b}^{ᵢ}(B_{m,i}−\overline{B}ᵢ)
B′_{m,i}=−2^{p-1}, where B′_{m,i}<−2^{p-1}
and B′_{m,i}=2ₚ₋₁−1, where B′_{m,i}>2^{p-1}−1
C′_{m,i}=2^{c}^{ᵢ}(C_{m,i}−\overline{C}ᵢ)
C′_{m,i}=−2ₚ₋₁, where C′_{m,i}<−2^{p-1}−1
and C′_{m,i}=2^{p-1}−1, where C′_{m,i}>2^{p-1}−1 (9)

When Equation (9) is substituted into Equation (5), the following equation is obtained.
[Expression 10]

$$\begin{matrix}Log P ( x \vert {ω}_{m} ) = \overline{A} + {\sum }_{i = 1}^{n} \{ {\overline{B}}_{i} {x}_{i}^{2} \} + {\sum }_{i = 1}^{n} \{ {\overline{C}}_{i} {x}_{i} \} + {2}^{- a} {A}_{m}^{′} + \\ {\sum }_{i = 1}^{n} \{ {2}^{- {b}_{i}} {B}_{m , i}^{′} {x}_{i}^{2} \} + {\sum }_{i = 1}^{n} \{ {2}^{- {c}_{i}} {C}_{m , i}^{′} {x}_{i} \}\end{matrix} \qquad ( 10 )$$

The terms including no variables m in Equation (10) are functioning as common bias components. Since only the magnitude relationship between log likelihoods is required for performing the recognition process, these terms need not be calculated. Therefore, the likelihood comparison can be performed according to the following equation, which is obtained by removing the terms including no variables m from Equation (10).
[Expression 11]

$$Log {P}^{′} ( x \vert {ω}_{m} ) = {2}^{- a} {A}_{m}^{′} + {\sum }_{i = 1}^{n} \{ {2}^{- {b}_{i}} {B}_{m , i}^{′} {x}_{i}^{2} \} + {\sum }_{i = 1}^{n} \{ {2}^{- {c}_{i}} {C}_{m , i}^{′} {x}_{i} \} \qquad ( 11 )$$

The calculation amount of Equation (11) is larger than that of Equation (5) by as much as the summation of 2n. However, this calculation can be achieved only by n-digit bit shifting. Therefore, the processing amount does not increase significantly.

Since quantization is performed, the scaling parameters a, bᵢ, and cᵢ are added and stored in the coefficient database 103. However, the entire data size is significantly reduced through quantization from 32 bit (where the database is constructed as a floating-type database) into p bit. For example, the total number of probability-density functions is determined to be 100, where the recognition process is performed by using 25-dimensional feature parameters. In this case, where the coefficient database 103 is constructed without performing quantization, the size thereof becomes, as shown below:
(1+25+25)×100×sizeof(float)=20,400 byte.

If quantization into 8 bit is performed here, the size of the coefficient database 103 becomes, as shown below:
(1+25+25)×100×sizeof(char)+(1+25+25)=5,151 byte.
   Therefore, the size is reduced to about one-quarter the original size, even though the scaling parameters are added to the database.

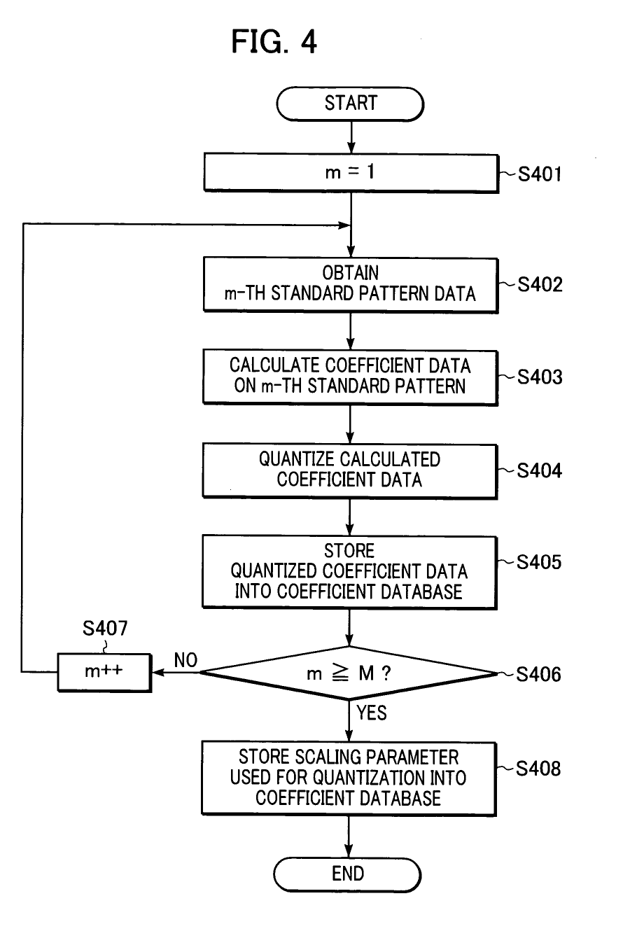

FIG. 4 is a flowchart showing a process for coefficient database construction according to the second embodiment. First, a counter variable m of a standard pattern to be processed is initialized to one, at step S401. Values including μ_{m,i}, σ2_{m,i}, and so forth, indicating a probability-density function forming the m-th standard pattern are obtained, at step S402.

Then, coefficient data (Aₘ, B_{m,i}, C_{m,i}, and so forth) are calculated from data including the obtained values including μ_{m,i}, σ2_{m,i}, and so forth, at step S403. Then, the calculated coefficient data is quantized by using Equations (6) to (9), at step S404. The quantized coefficient data corresponds to A′ₘ, B′_{m,i}, and C′_{m,i} shown in Equation (9). The quantized coefficient data is stored in the coefficient database 103, at step S405.

It is determined whether or not the value of the counter variable m exceeds the total number M of standard patterns, at step S406. If the value exceeds the total number M, the processing advances to step S408. Otherwise, the processing advances to step S407 where the value of the counter variable m is incremented by one. Then, the process returns to step S402, and the process steps S402 to S405 are repeated. In the above-described manner, the steps S402 to S405 are performed for all standard patterns.

Then, the scaling parameters are stored in the coefficient database 103, at step S408. In the above-described embodiment, a, bᵢ, and cᵢ are stored as the scaling parameters.

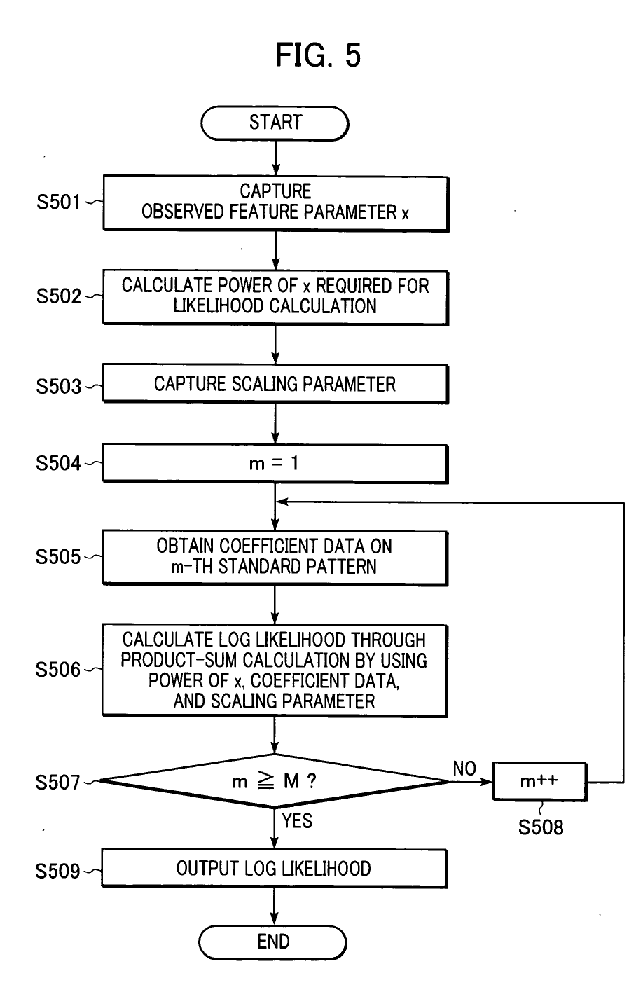

FIG. 5 is a flowchart illustrating a process for likelihood calculation according to this second embodiment.

First, the observed-feature parameter capturing unit 105 captures observed feature parameter x, at step S501. The observed-feature parameter preprocessing unit 106 calculates the power of x required for the likelihood calculation, at step S502. At this time, x2 is calculated, where the likelihood calculation is performed by using Equation (11).

The scaling parameter is obtained from the coefficient database 103, at step S503.

The likelihood calculation unit 107 performs the processing of steps S504 to S508. First, the counter variable m of a standard pattern to be processed is initialized to one, at step S504. The quantized m-th coefficient data is obtained from the coefficient database 103, at step S505. This quantized coefficient data in the coefficient database 103 is generated through the coefficient-database construction process performed by the standard-pattern preprocessing unit 109. Then, product-sum calculation is performed according to Equation (11) by using the quantized coefficient data, the power of x calculated at step S502, and the scaling parameter obtained at step S503. Subsequently, a log likelihood is calculated, at step S506.

It is determined whether or not the value of the counter variable m exceeds the total number M of standard patterns, at step S507. If the value exceeds the total number M, the process advances to step S509. Otherwise, the process advances to step S508 so that the value of the counter variable m is incremented by one. Then, the process returns to step S505, so that steps S505 to S507 are repeated. In the above-described manner, steps S505 and S506 are performed for all standard patterns.

Then, at step S509, the likelihood output unit 108 outputs the log likelihood calculated through the above-described process.

In the above-described embodiment, a single n-dimensional probability-density function forms one standard pattern. However, a plurality of the n-dimensional probability-density functions may form a single standard pattern. Further, the n-dimensional probability-density functions may be shared among the standard patterns.

The likelihood-calculation process of the present invention may be used for speech-recognition processing using a hidden-Markov-model (HMM) method. Since the speech-recognition processing using the HMM method is widely known, the description thereof is omitted. The likelihood-calculation processing of the present invention can be used for calculating HMM output probability.

According to the above-described embodiments, the likelihood calculation using probability-density distribution can be performed only by product-sum calculation. Subsequently, the likelihood calculation can be performed with high speed by a device equipped with a product-sum calculation instruction. (e.g. Multiply and Accumulation processor). Further, since complicated calculation is performed beforehand, as preprocessing, a quantization error caused by fixed-point processing can be reduced. Further, since the coefficient data used for the product-sum calculation is quantized, a data storage area for storing the coefficient data can be reduced.

Other Embodiments

The embodiments of the present invention have been described. The present invention can be embodied in a system, a device, a method, a program, a storage medium, and so forth. Further, the present invention can be used for a system including a plurality of devices, or an apparatus including a single device.

Further, the present invention can also be achieved by supplying the program code of software for implementing the functions of the above-described embodiments directly or from a distance to a system or an apparatus so that a computer of the system or apparatus reads and executes the supplied program code. In this case, the software is not necessarily the program code, as long as it has the program function.

Subsequently, the program code itself, installed in the computer so that the computer performs the functions of the present invention, achieves the present invention. That is to say, the scope of the present invention includes a computer program for achieving the functions of the present invention.

In this case, the form of the program is not limited, as long as it has a program function. That is to say, a program carried out by an object code and an interpreter, script data supplied to an OS, and so forth, can be used.

The storage medium for providing the program code may be, for example, a flexible disk, a hard disk, an optical disk, a magneto-optical disk, an MO, a CD-ROM, a CD-R, a CD-RW, a magnetic tape, a non-volatile memory card, a ROM, a DVD (a DVD-ROM and a DVD-R), and so forth.

The program may be supplied by accessing a home page on the Internet via the browser of a client computer and downloading a computer program of the present invention, or a compressed file including an automatic install function from the home page to a recording medium including a hard disk or the like. Further, the program may be supplied by dividing the program code constituting the program of the present invention into a plurality of files and downloading the files from different home pages. That is to say, a WWW server is included in the scope of the present invention, where the WWW server is used for downloading program files that can be executed by a computer to a plurality of users, the program files being used for achieving the functions of the present invention by a computer.

The program of the present invention may be ciphered, stored in a recording medium such as a CD-ROM, and distributed to the users. Further, key information for deciphering the ciphered program may be downloaded from the home page to a user who passes a predetermined condition via the Internet. Subsequently, the ciphered program can be executed by using the key information and installed in a computer of the user, so as to achieve the functions of the present invention.

In another embodiment, the functions of the above-described embodiments may be achieved by the computer executing the read program, and an OS or the like running on the computer may perform part or entire processing based on instructions of the program code, whereby the functions of the above-described embodiments can be achieved.

In another embodiment of the present invention, the program read from the recording medium may be written to a memory of a function extension board inserted in the computer or a function extension unit connected to the computer. The functions of the above-described embodiments may be realized by executing part of or the entire process by a CPU, etc. of the function extension board or the function extension unit based on instructions of the program.

According to the present invention, likelihood calculation for recognition processing using a probability-density distribution can be performed with high speed and precision by a device with limited calculation resources.

While the present invention has been described with reference to what is presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A device for calculating likelihood of an observed feature parameter for a plurality of standard patterns including a first standard pattern, the device comprising:
a processing unit configured to generate a set of coefficients of power series of the observed feature parameter corresponding to the first standard pattern;
a first calculation unit calculating a power of the observed feature parameter; and
a second calculation unit calculating the likelihood for the first standard pattern.

2. A device according to claim 1, wherein the processing unit generates the set of coefficients by preprocessing a probability density distribution corresponding to the first standard pattern.

3. A device according to claim 1, further comprising a database storing the set of coefficients.

4. A device according to claim 1, wherein the second calculation unit calculates the likelihood of the first standard pattern via a product-sum calculation based on the power of the observed feature parameter and the set of coefficients.

5. A device according to claim 1, wherein the processing unit is configured to quantize the set of coefficients according to a quantization width based on a standard deviation of the set of coefficients for the plurality of standard patterns.

6. A device according to claim 5, further comprising a database storing the quantized set of coefficients.

7. A device according to claim 6, wherein the database stores a set of scaling parameters corresponding to the quantized set of coefficients.

8. A device according to claim 7, wherein the second calculation unit calculates the likelihood of the first standard pattern via a product-sum calculation based on the power of the observed feature parameter, the quantized set of coefficients, and the corresponding set of scaling parameters.

9. A device according to claim 1, wherein the first calculation unit further calculates a square of the observed feature parameter.

10. A method for calculating likelihood of an observed feature parameter for each of a plurality of standard patterns, the method comprising the steps of:
capturing each of the plurality of standard patterns;
generating a set of coefficients of power series of the observed feature parameter for each of the captured standard pattern;
calculating a power of the observed feature parameter for each of the captured standard pattern; and
calculating the likelihood for each of the captured standard pattern.

11. A method according to claim 10, further comprising storing the set of coefficients for each of the plurality of standard patterns.

12. A method according to claim 11, wherein calculating the likelihood includes performing a product-sum calculation based on the power of the observed feature parameter and the set of coefficients.

13. A method according to claim 10, further comprising:
quantizing the set of coefficients according to a quantization width based on a standard deviation of the set of coefficients for the plurality of standard patterns; and
providing a set of scaling parameters corresponding to the quantized set of coefficients.

14. A method according to claim 13, further comprising storing the quantized set of coefficients and the set of scaling parameters.

15. A method according to claim 14, wherein calculating the likelihood includes performing a product-sum calculation based on the power of the observed feature parameter, the quantized set of coefficients, and the corresponding set of scaling parameters.

16. A method according to claim 10., wherein calculating the power includes calculating a square of the observed feature parameter.

17. A speech recognition device configured to calculate likelihood of HMM according to a method according to claim 10.

18. A computer-readable medium having computer-executable instructions for calculating a likelihood of an observed feature parameter for each of a plurality of standard patterns comprising the steps of:
capturing each of the plurality of standard patterns;
generating a set of coefficients of power series of the observed feature parameter for each of the captured standard patterns;
calculating a power of the observed feature parameter for each of the captured standard patterns; and
calculating the likelihood for each of the captured standard patterns.
